(19) United States
(12) Patent Application Publication
(10) Pub. No.: US 2015/0199571 A1
(43) Pub. Date: Jul. 16, 2015

(54) POS TERMINAL APPARATUS AND CUSTOMER INFORMATION ACQUISITION METHOD

(71) Applicant: TOSHIBA TEC KABUSHIKI KAISHA, Tokyo (JP)

(72) Inventor: Hiroyuki Okuyama, Kanagawa-ken (JP)

(73) Assignee: TOSHIBA TEC KABUSHIKI KAISHA, Tokyo (JP)

(21) Appl. No.: 14/156,784

(22) Filed: Jan. 16, 2014

(51) Int. Cl. G06K 9/00; G06Q 20/20

(52) U.S. Cl. CPC G06K 9/00624; G06Q 20/208; G06K 9/00221

(57) ABSTRACT

In accordance with an embodiment, a POS terminal apparatus comprises a display section and a control section. The control section calculates the feature amount of the people contained in the image data captured by an image capturing section. The control section specifies the age group and the gender of the people in the image data based on the data stored in a storage section and associating the age group information and the gender information of a people with a pre-calculated feature amount and the calculated feature amount. The control section displays the specified age group information and gender information on a display section.

### FIELD

Embodiments described herein relate to a technology using an image recognition technology.

### BACKGROUND

In order to investigate customer groups, a store sometimes collects the age and the gender of the customers shopping in the store. The information is used for marketing strategy such as commodity purchasing data.

In the past, attribute information such as age and gender and the like is registered by pressing the classify key on a POS (Point of Sales) terminal apparatus.

However, an input error when the operator of the POS terminal apparatus presses the classify key or a time loss with the key being pressed may occur.

### BRIEF DESCRIPTION OF THE DRAWINGS

FIG. 1 is an oblique view illustrating a system according to an embodiment;

FIG. 2 is a block diagram illustrating an example of hardware configurations of a POS terminal and a commodity reading apparatus;

FIG. 3A is a diagram illustrating an example of a first feature file, and FIG. 3B is a diagram illustrating an example of a second feature file; and

FIG. 4 is a flowchart illustrating an example of the operations carried out in the embodiment.

### DETAILED DESCRIPTION

In accordance with an embodiment, a POS terminal apparatus comprises a display section and a control section. The control section calculates the feature amount of the people contained in the image data captured by an image capturing section. The control section specifies the age group and the gender of the people contained in the image data based on the data stored in a storage section and associated age group information and gender information of people with pre-calculated feature amounts and the calculated feature amount. The control section displays specified age group information and gender information on a display section.

A camera is arranged in the periphery of the POS terminal apparatus of the embodiment, a feature amount is calculated based on the image data acquired by the camera to acquire the attribute information, such as the age group and the gender, of a customer. There is an advantage that when acquiring the attribution information, there is no need to have the cooperation with the customer in the embodiment. Further, the camera may be the monitoring camera had been arranged before.

When recognizing the age group and the gender of a customer, the POS terminal apparatus of the embodiment extracts, from an captured image, a first feature amount numerically representing the relative position and the size of the face parts of the customer, the shapes of the eyes, the nose, the cheekbone and the chin of the customer and the concave/convex shape of the face and uses the first feature amount. Further, when recognizing the age group and the gender of a customer, the POS terminal apparatus of the embodiment extracts, from an image captured, a second feature amount numerically representing the sizes, the tone and the concave/convex shape of the decoration, such as the clothes or ornaments worn on the customer rather than the face parts of the customer and uses the second feature amount. Then, the POS terminal apparatus specifies attribute information such as an age group and a gender based on the first and second feature amounts and displays the specified attribute information on the display section. If the displayed attribute information is apparently different, the operator of the POS terminal apparatus modifies the attribute information. Thus, the POS terminal apparatus described herein comprises a correction mechanism in the case of erroneous detection.

The installation location of the POS terminal apparatus sometimes makes it difficult to position the camera facing the front face of the customer, thus, it is impossible to carry out a face recognition at a sufficient precision only according to the first feature amount (the feature amount of the face of the customer), as a consequence, sometimes it is difficult to specify the obtained age group and the gender. Thus, in the embodiment, the feature amount of the decorations, such as the clothes, worn on a customer is calculated as a second feature amount, including this, to specify the age group and the gender of the customer.

Embodiments are described below with reference to accompanying drawings.

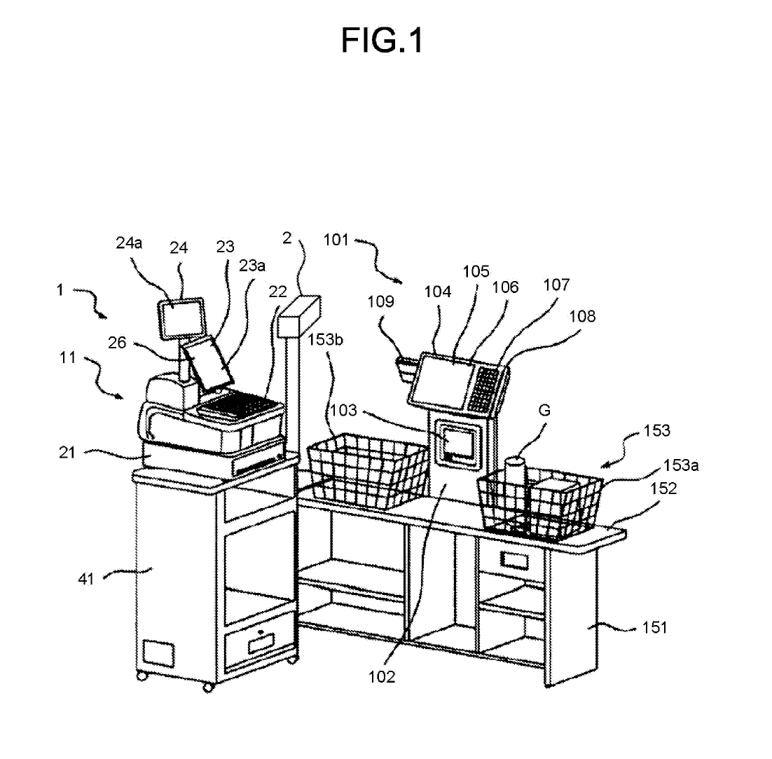

FIG. 1 is a diagram illustrating an example of the appearance of a checkout system. As shown in FIG. 1, the checkout system 1 comprises a commodity reading apparatus 101 configured to read information relating to commodities and a POS terminal 11 configured to carry out the registration and settlement for commodities involved in a transaction. Further, the same configuration shown in the accompanying drawings are denoted by the same reference signs and are therefore not described repeatedly in the following description.

The POS terminal 11 is placed on the upper surface of a drawer 21 on a checkout table 41. The drawer 21 is opened under the control of the POS terminal 11. A keyboard 22 is configured on the upper surface of the POS terminal 11 for the operator to press. Seen from the operator, a display device 23 which displays information facing the operator is arranged more inward than the keyboard 22. The display device 23 displays information on the display surface 23a thereof. A touch panel 26 is laminated on the display surface 23a. A rotatable display device 24 for customer is arranged more inward than the display device 23.

A camera 2 is arranged on the right side of the display device 23 and the keyboard 22. The camera 2 faces the direction in which the customer purchasing commodities is image captured. The camera 2 is not limited to be arranged at the position shown in FIG. 1. Preferably, the camera 2 is arranged at a position where no inconvenience is caused when using the checkout system 1, or the camera 2 may be the monitoring camera had been arranged before.

A long desk-shaped counter table 151 is arranged to form an L shape with the checkout counter 41 on which the POS terminal 11 is arranged. A load receiving surface 152 is formed on the upper surface of the counter table 151. A shopping basket 153 for accommodating a commodity G is placed on the load receiving surface 152. It may be considered to classify the shopping basket 153 into a first shopping basket 153a held by a customer and a second shopping basket 153b across the commodity reading apparatus 101 from the first shopping basket 153a. Further, the shopping basket 153, which is not limited to take the shape of a basket, may also be in a tray shape. Further, the second shopping basket 153b, which is not limited to take the shape of a basket, may also be in a box or bag shape.

The commodity reading apparatus 101, which is connected with the POS terminal 11 to transmit and receive data, is arranged on the commodity receiving surface 152 of the counter table 151. The commodity reading apparatus 101 has a thin rectangular housing 102. A reading window 103 is arranged on the front surface of the housing 102. A display operation section 104 is installed on the upper of the housing 102. A display device 106 having a touch panel 105 laminated on the surface thereof is arranged on the display operation section 104. A keyboard 107 is arranged on the neighbor to the right side of the display device 106. The card reading slot 108 of a card reader (not shown) is arranged on the neighbor to the right side of the keyboard 107. Seen from the operator, a display device 109 for customer is arranged at a left inward side position with respect to the display operation section 104 so as to provide information for a customer.

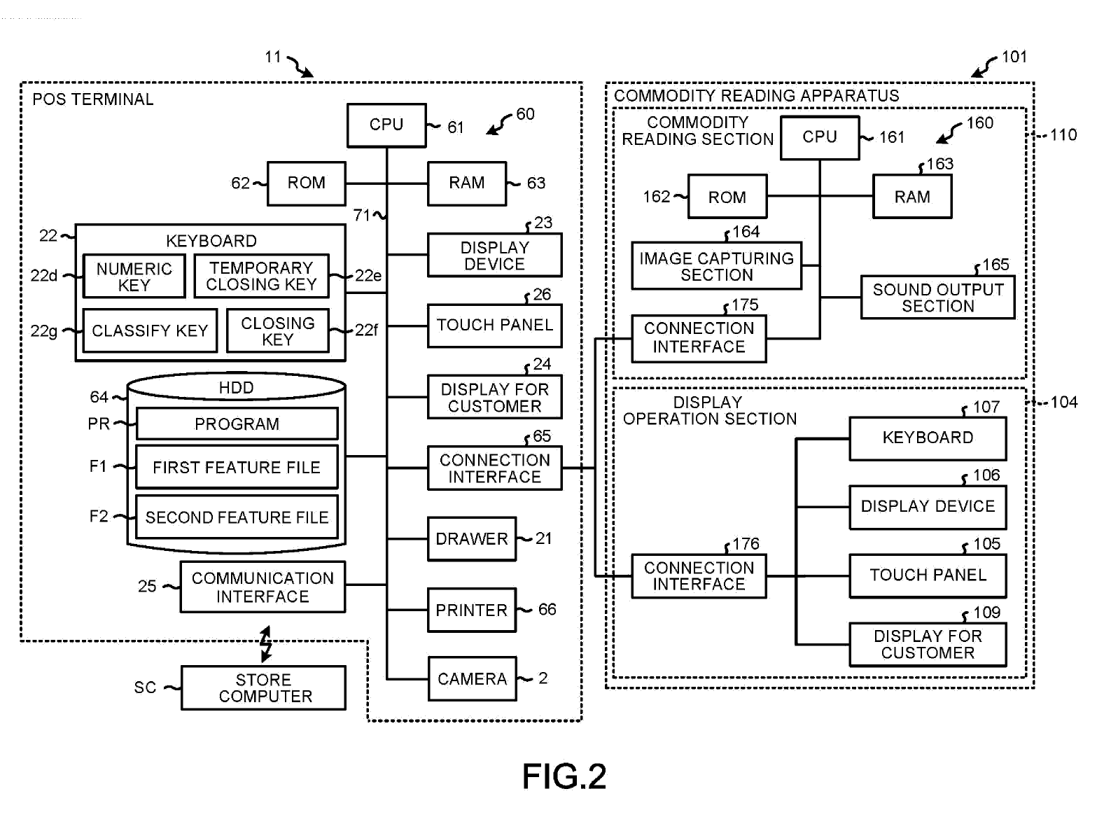

The commodity reading apparatus 101 comprises a commodity reading section 110 (refer to FIG. 2), which has an image capturing section 164 (refer to FIG. 2) in the rear side in the reading window 103.

A commodity G is accommodated in the first shopping basket 153a held by a customer. The commodity G in the first shopping basket 153a is moved into the second shopping basket 153b by the operator of the commodity reading apparatus 101. When moved, the commodity G faces the reading window 103 of the commodity reading apparatus 101. At this time, the image capturing section 164 (refer to FIG. 2) arranged in the reading window 103 image captures the image of the commodity G.

The commodity reading apparatus 101 sends the image captured by the image capturing section 164 to the POS terminal 11. The POS terminal 11 determines which one of the commodities registered in advance is corresponding to the commodity G through an object recognition processing. The POS terminal 11 records, based on a specified commodity code, the information of commodities according to the sales registration, such as the commodity category, the commodity name and the unit price corresponding to the commodity code in a sales master file (not shown).

The camera 2 captures the image of a customer during the period of carrying out aforementioned checkout operation. Based on the frame images captured by the camera 2 as well as a first feature file F1 and a second feature file F2 which will be described later, the POS terminal 11 specifies the age group and the gender of a customer using an object recognition technology. The POS terminal 11 displays attribute information such as the specified age group and gender on the display device 23. If the attribute information displayed is apparently different, the operator makes a correction. The POS terminal 11 records the finally obtained attribute information such as age group information and gender information in the aforementioned sales master file (not shown) to conduct sales registration. Further, when the attribute information is corrected by the operator, the corrected attribute information, the first feature amount and the second feature amount obtained during the processing process are additionally written into the first feature file F1 and the second feature file F2.

FIG. 2 is a block diagram illustrating hardware configurations of the POS terminal 11 and the commodity reading apparatus 101. As shown in FIG. 2, the POS terminal 11 and the commodity reading section 110 and the display operation section 104 of the commodity reading apparatus 101 can carry out data transmission/reception with each other through connection interfaces 65, 175 and 176.

The POS terminal 11 comprises a microcomputer 60 for executing an information processing. The microcomputer 60 is a structure in which a CPU (Central Processing Section) 61, that is, a processor, which carries out various arithmetic processing to control each section is connected with a ROM (Read Only Memory) 62 and a RAM (Random Access Memory) 63 via a communication bus 71. Further, the microcomputer 60 is connected with each piece of hardware in the POS terminal 11 through the communication bus 71 to transmit or receive a control signal and data.

The CPU 61 of the POS terminal 11 is connected with the aforementioned drawer 21, keyboard 22, display device 23, touch panel 26 and display device 24 for customer, which are controlled by the CPU 61, through various input/output circuits (not shown).

The keyboard 22 has a numeric key 22d, a temporary closing key 22e and a closing key 22f on the upper surface of which operators including numeric characters such as ‘1’, ‘2’, ‘3’ and a multiplying operator are displayed. Moreover, the temporary closing key 22e is a button which is pressed when a checkout processing is temporarily completed, and the closing key 22f is a button which is pressed after all commodities are processed and a checkout processing is confirmed. Further, the keyboard 22 has classify key 22g. The classify key 22g includes buttons on the surface of which age groups such as ‘teens’, ‘twenties’, ‘thirties’ and the like are displayed and buttons on the surface of which gender ‘male’ or ‘female’ is displayed.

The CPU 61 of the POS terminal 11 is connected with an HDD 64 (Hard Disk Drive), in which programs and various files are stored. When the POS terminal 11 is started, the programs and files stored in the HDD 64 are completely or partially copied into the RAM 63 and executed by the CPU 61. In this way, the microcomputer 60 controls each piece of hardware in the POS terminal 11. An example of the programs stored in the HDD 64 is a program for a commodity sales data processing or a program PR for acquiring the age group and the gender of a customer from the images captured. An example of the files stored in the HDD 64 is a first feature file F1 and a second feature file F2 in which feature parameters are set in advance. The first feature file F1 and the second feature file F2 will be described in detail later. Further, the HDD 64 stores the PLU file and each threshold value file which are sent from and stored in the store computer SC through the communication interface 25.

The communication interface 25 is a unit which controls the data communication with the store computer SC.

Further, the POS terminal 11 comprise a printer 66, which outputs a receipt printed after a checkout processing for the purchased commodities is carried out.

The camera 2 comprising a color CCD (Charged Coupled Device) image sensor or a color CMOS (Complementary Metal Oxide Semiconductor) image sensor captures the image of a customer under the control of the CPU 61. That is, the camera 2 captures an image containing the face, the decorations such as the clothes and the ornaments, of a customer. For example, the camera 2 captures dynamic images at 30 fps. The camera 2 stores the frame images successively captured at a given frame rate in the RAM 63.

The commodity reading section 110 of the commodity reading apparatus 101 comprises a microcomputer 160 for executing an information processing. The microcomputer 160 is a structure in which a CPU 161 is connected with a ROM 162 and a RAM 163 through a bus. The CPU 161 develops the programs (e.g. a program for image capturing) stored in the ROM 162 in the RAM 163 and then executes the program. In this way, the microcomputer 160 controls each piece of hardware in the commodity reading apparatus 101. Further, the commodity reading section 110 comprises a sound output section 165 configured to output a reading confirmation sound when the commodity reading section 110 reads a commodity.

The image capturing section 164 comprises a color CCD image sensor or a color CMOS image sensor. The image capturing section 164 captures the image of a supplied commodity under the control of the CPU 61. The image capturing section 164 stores the frame images successively captured at a given frame rate in the RAM 163.

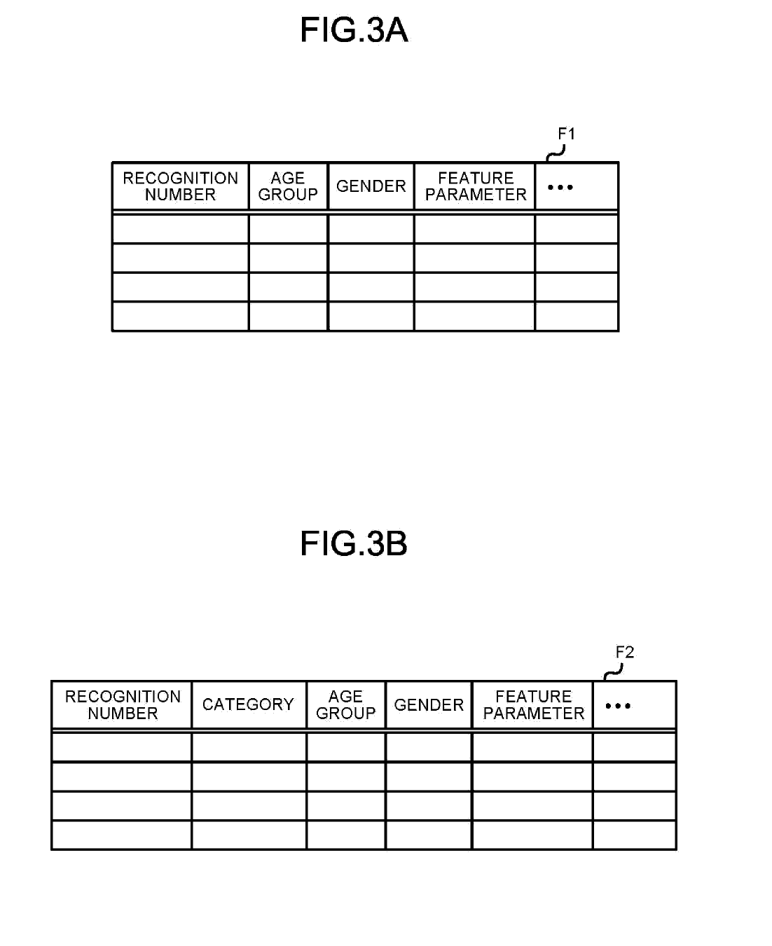

Next, the data used for specifying the age group and the gender of a customer is described with reference to FIG. 3. First, FIG. 3A shows an example of the data configurations of the first feature file F1 stored in the HDD 64 of the POS terminal 11. The first feature file F1 is data associating the recognition number of the record with an age group information, a gender information and pre-calculated feature amount (feature parameters) of face. The feature amount (feature parameter) is data numerically representing the relative position and the size of a face parts, the shapes of eyes, nose, cheekbone and chin, the tone and the concave/convex of the face surface.

The creating of the first feature file F1 is described herein. The first feature file F1 may be created by the POS terminal 11 or other computers. First, the face of a people of a known age group and a known gender is image captured, and the feature amount of the face in the image is calculated. The age group information, the gender information and the feature amount of the face are associated to form a record, which is affixed with a recognition number and then registered in the first feature file F1. The procedure should be carried out for as many times as possible in advance, thereby increasing the number of samples. Further, the first feature file F1 may be added and updated during the period the POS terminal 11 is used in a store. This embodiment will be described in detail later.

FIG. 3B shows an example of the data configuration of the second feature file F2 stored in the HDD 64 of the POS terminal 11. The second feature file F2 is data associating the recognition number of the record with the category information of ornaments such as ‘clothes’, ‘watch’ and ‘necktie’, age group information, gender information and a pre-calculated feature amount (feature parameter) of the ornaments. Further, for the sake of recognition precision, the category of the ornament may be limited to be ‘clothes’ only.

The second feature file F2 is creates in the way the first feature file F1 is created. That is, a people of a known age group and a known gender wearing the clothes and the ornaments the people usually wears is image captured, and the feature amount of the ornaments in the image is calculated. The age group information, the gender information and the feature amount of the ornaments are associated to forma record, which is affixed with a recognition number and then registered in the second feature file F2. The procedure should be carried out for as many times as possible in advance, thereby increasing the number of samples. Further, the second feature file F2 may be added and updated during the period the POS terminal 11 is used in a store. This embodiment will be described in detail later.

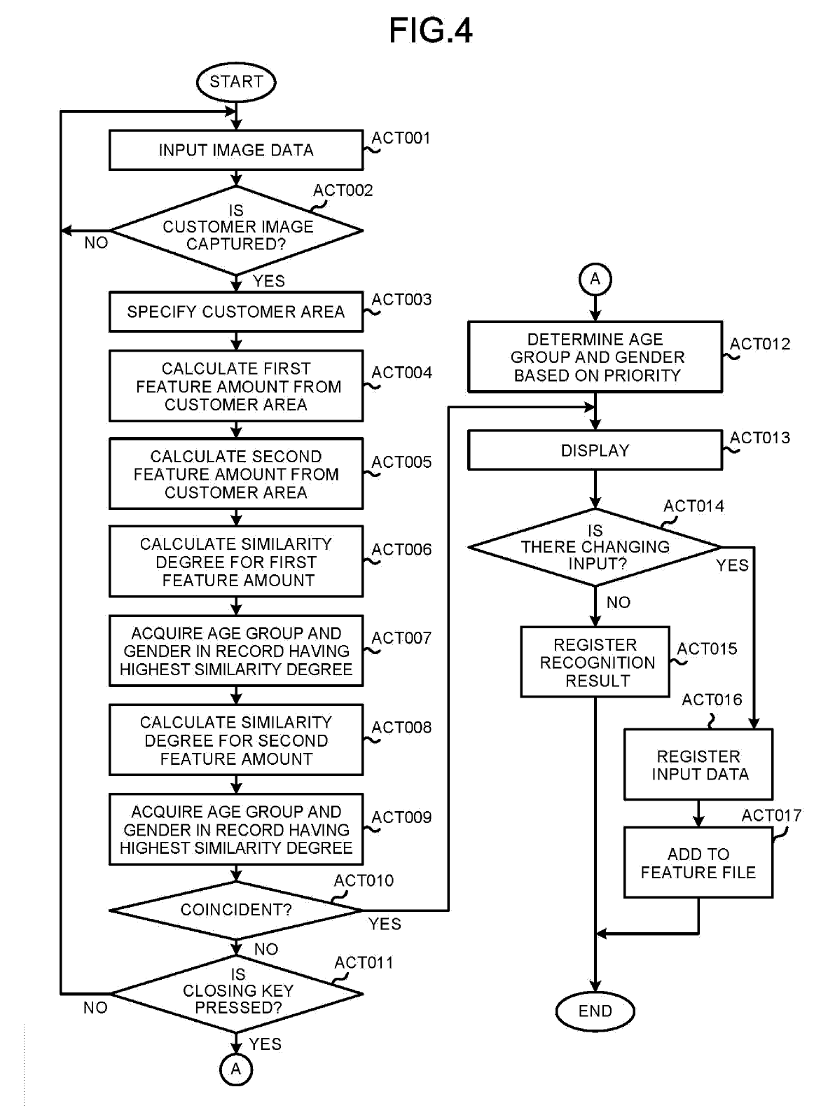

FIG. 4 is a flowchart illustrating an example of the operations carried out to specify the age group and the gender of a customer using the image obtained from the camera 2, the first feature file F1 and the second feature file F2. The flowchart shown in FIG. 4 is realized by developing and executing the program pre-imported in the HDD 64 in the RAM 63 by the CPU 61 of the POS terminal 11. Further, the operations shown in the flowchart of FIG. 4 are implemented during the period the checkout operation for commodities is carried out as stated above.

The CPU 61 of the POS terminal 11 outputs a video-on signal to the camera 2 to start the image capturing operation of the camera 2. After the image capturing operation is started, the image data captured by the camera 2 is imported orderly in the RAM 63 under the control of the CPU 61. The CPU 61 acquires the image data imported in the RAM 63 (ACT 001) and determines whether or not there is the image of a customer (people) in the image. Specifically, the CPU 61 compares an image captured with no customer is captured with the current image captured to determine whether or not there is an image of a customer. The flow returns to ACT 001 if there is no image of a customer in the image (NO in ACT 002). If there is an image of a customer in the image (YES in ACT 002), the CPU 61 binarizes the image and extracts a contour line to specify an area where the customer is displayed (ACT 003). The area is referred herein to as a customer area.

The CPU 61 calculates a first feature amount from the customer area (ACT 004). The first feature amount is the feature amount of the face of the customer. The CPU 61 specifies a face area from the customer area based on the tone such as the color of skin, the position and the size in the image to calculate the feature amount in the face area. Further, the CPU 61 calculates a second feature amount from the customer area (ACT 005). The second feature amount is the feature amount of the ornaments such as the cloth of the customer. The CPU 61 further specifies the area of ornaments such as a cloth from the customer area based on the positions, the sizes and the contour lines in the image and calculates the feature amount in the ornaments area (ACT 005).

The CPU 61 compares the calculated first feature amount (the feature amount of the face) with each feature parameter registered in the first feature file F1 to calculate the similarity degree of each record in the first feature file F1 (ACT 006). The similarity degree is information numerically representing how similar the first feature amount (value data) obtained from the captured image is to the feature parameter (value data) in the first feature file F1. When the similarity degree is calculated, the surface concave/convex of the face surface in the feature amount can be weighted as an important factor. The CPU 61 acquires, from the first feature file F1, the record in which the feature parameter has the maximum similarity degree and acquires the age group and the gender in the record (ACT 007).

Further, the CPU 61 compares the calculated second feature amount (the feature amount of the ornaments) with each feature parameter registered in the second feature file F2 to calculate the similarity degree of all records in the second feature file F2 (ACT 008). The CPU 61 acquires, from the second feature file F2, the record in which the feature parameter has the maximum similarity degree and acquires the age group and the gender in the record (ACT 009).

The CPU 61 determines whether or not the age group and the gender acquired using the first feature amount coincides with those acquired using the second feature amount (ACT 010). If the age group and the gender are coincident, the CPU 61 determines the age group and the gender, and then the flow proceeds to ACT 013. If either of or both of the age group and the gender acquired aren't coincident (NO in ACT), the CPU 61 determines whether or not the closing key 22f on the keyboard 22 is pressed (ACT 011). If the closing key 22f is not pressed (NO in ACT 011), the flow returns to ACT 001 so that the CPU 61 acquires the next frame image (ACT 001), and then ACT 002-ACT 010 are repeatedly carried out. Further, when the flow returns to ACT 001 from ACT 011, the RAM 63 associates the first feature amount obtained in the current operation with the age group and the gender obtained based on the first feature amount and then stores the information temporarily. Further, the RAM 63 associates the second feature amount obtained in the current operation with the age group and the gender obtained based on the second feature amount and then stores the information temporarily.

Further, if the age group and the gender acquired are not coincident (NO in ACT 010) and the closing key 22f is pressed (YES in ACT 011), the CPU 61 determines an age group and a gender based on a priority (ACT 012). The priority is used to define which age group and which gender is adopted first. For example, if it is defined that the age group and the gender acquired using the first feature amount are prior to those using the second feature amount, then the CPU 61 determines the age group and the gender obtained using the first feature amount. Further, in the example, the age group and the gender obtained using the first feature amount is adopted first, the age group and the gender obtained using the second feature amount may also be adopted first. Further, when a plurality of age groups and genders are obtained through a loop processing carried out based on the determination result in ACT 011, the CPU 61 adopts the age group and the gender which are specified for most times. Further, when the closing key 22f is pressed, the flow proceeds to ACT 012 even if any of ACT 001 to ACT 010 is carried out.

In ACT 013, the CPU 61 displays the determined age group and gender on the display device 23 (ACT 013). The operator compares the appearance age group and gender of the customer with those displayed, if determined that there is an apparent recognition error, operates the classify key 22g to correct the error. Here, if there is no correction input (NO in ACT 014), the age group and gender displayed are registered in the sales master file (ACT 015). On the other hand, if a correction input from the classify key 22g is accepted (YES in ACT 014), the CPU 61 registers the corrected age group and gender in the sales master file (ACT 016). Further, the CPU 61 associates the corrected age group and gender with the calculated first feature amount, adds a recognition number to be added and registered to the first feature file F1 (ACT 017). Similarly, the CPU 61 associates the corrected age group and gender with the calculated second feature amount, adds a recognition number to be added and registered to the second feature file F2 (ACT 017). If a plurality of first feature amounts are obtained according to the determination result in ACT 004, for example, the average value of the first feature amounts excluding the ones becoming extreme deviations is calculated and then added and registered. The same operations are carried out in a case where a plurality of second feature amounts are obtained. In this way, the information amount of the first feature file F1 and the second feature file F2 are accumulated even if being used, thereby improving the accuracy of a recognition result. Further, the customers shopping in a store are fixed to some extent; therefore, by registering the feature amount of the customers, the recognition accuracy can be improved.

The implementation on storing the first feature file F1 and the second feature file F2 in the HDD 64 in the POS terminal 11 is described in the embodiment, however, the files may also be stored in the storage section of an external apparatus such as a store computer SC. In this case, the CPU 61 activates the communication interface 25 to acquire data from the storage section of the external apparatus to carry out a calculation of a similarity degree. Further, the CPU 61 activates the communication interface 25 to output the corrected age group information and gender information as well as the calculated first and second feature amounts to the storage section of the external apparatus in ACT 017.

The display section is equivalent to the display device 23 according to the embodiment, and the image capturing section is equivalent to the camera 2 according to the embodiment. The storage section is equivalent to the HDD 64 according to the embodiment, and the control section is equivalent to the microcomputer 60 including the CPU 61 according to the embodiment. The input section is equivalent to the keyboard 22 having the classify key 22g according to the embodiment. Further, the objects worn by a people include ornaments such as a watch and a necklace and clothes that is worn on. The image capturing section is an external apparatus such as existing monitoring camera, and the storage section may be an external apparatus.

In this embodiment, the functions of the present invention are prerecorded in the apparatus, however, the present invention is not limited to this case, the same functions may also be downloaded to the apparatus from a network or stored in a recording medium and then installed in the apparatus. The recording medium may be any recording medium that is capable of storing programs and machine-readable, such as a CD-ROM and the like. Further, the function achieved by an installation or downloading of programs can also be achieved through the cooperation with the OS (Operating System) inside the apparatus.

In the embodiment, input work can be relieved when the age group and the gender of a customer is input using the POS terminal apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A POS terminal apparatus, comprising:
a display section; and
a control section configured to calculate the feature amount of the people in the image data captured by the image capturing section, specify the age group and the gender of the people in the image data based on the data stored in a storage section and associating the age group information and the gender information of a people with a pre-calculated feature amount and the calculated feature amount.

2. The POS terminal apparatus according to claim 1, wherein
the storage section stores the data associating pre-calculated feature amounts of faces, age group information and gender information, and
the control section specifies an area in which a face is displayed according to the image data, calculates the feature amount in the area of the face and specifies the age group and the gender of the people in the image data based on the feature amount and the data.

3. The POS terminal apparatus according to claim 1, wherein
the storage section stores the data associating pre-calculated feature amounts of the objects worn on a people, age group information and gender information, and
the control section specifies an area in which the objects worn on a people are displayed according to the image data, calculates the feature amount in the area of the objects and specifies the age group and the gender of the people in the image data based on the feature amount and the data.

4. The POS terminal apparatus according to claim 1, further comprising:
an input section, wherein
when the input section accepts either or both of age group information and gender information, the control section corrects the age group information and gender information displayed on the display section.

5. The POS terminal apparatus according to claim 4, wherein
the control section stores the calculated feature amount and the corrected age group information and gender information in the storage section.

6. A customer information acquisition method for a POS terminal apparatus, comprising:
calculating the feature amount of the people in the image data captured by an image capturing section;
acquiring the data which is stored in a storage section and associates pre-calculated feature amounts, age group information and gender information,
specifying the age group and the gender of the people in the image data based on the calculated feature amount and the acquire data; and
displaying the specified age group information and gender information on a display section.

7. The method according to claim 6, wherein
an area in which a face is displayed is specified according to the image data, and the feature amount in the area of the face is calculated;
the data associating pre-calculated feature amounts of the face, age group information and gender information is acquired from the storage section; and
specifying the age group and the gender of the people in the image data based on the calculated feature amount of the face and the acquired data.

8. The method according to claim 6, wherein
an area in which the objects worn on a people is displayed is specified according to the image data, and the feature amount in the area of the objects is calculated;
the data associating pre-calculated feature amounts of the objects worn on a people, age group information and gender information is acquired from the storage section, and
specifying the age group and the gender of the people in the image data based on the calculated feature amount and acquired the data.

9. The method according to claim 6, wherein
when an input section accepts either or both of age group information and gender information, the age group information and gender information displayed on the display section is corrected.

10. The method according to claim 9, wherein
the calculated feature amount and the corrected age group information and gender information are stored in the storage section.
